(19) United States
(12) Patent Application Publication
(10) Pub. No.: US 2017/0228672 A1
(43) Pub. Date: Aug. 10, 2017

(54) METHOD, APPARATUS, AND SYSTEM FOR GENERATING BUSINESS MODEL, AND COMPUTER READABLE STORAGE MEDIUM

(71) Applicant: Shenzhen Development Promotion Centre for Enterprises, Shenzhen Guangdong (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, SHENZHEN GUANGDONG (CN)

(21) Appl. No.: 15/018,315

(22) Filed: Feb. 8, 2016

(51) Int. Cl. G06Q 10/06

(52) U.S. Cl. CPC G06Q 10/067

(57) ABSTRACT

A method, an apparatus, and a system for generating a business model, and a computer readable storage medium are disclosed. Stakeholders, activities, and resources are sliced according to obtained stakeholder information, activity information, and resource information in a symbiosis scope, so that fine-granularity stakeholders, activities, and resources are obtained; the fine-granularity stakeholders, activities, and resources are regrouped, and a series of new business models is generated. Innovations of business models are implemented, and the generated series of business models may be provided for an enterprise to make a selection according to conditions of the enterprise.

### TECHNICAL FIELD

The present invention relates to the data analysis processing field, and in particular, to a method, an apparatus, and a system for generating a business model, and a computer readable storage medium.

### BACKGROUND

With continuous advancement of science and technology and continuous development of innovations, how to successfully apply a new invention or creative idea to business operation and enterprise development to achieve operational performance is a common concern in various industries of the society. The concept of business model is put forward just to set up a bridge between creative idea and enterprise operation.

A good business model may effectively increase transaction value, and reduce transaction cost and transaction risk. Currently, there is no definite manner or method for designing a business model. Generation of a good business model is always a result of unique experience and inspiration of an entrepreneur. This greatly constrains realization of value of the business model in an enterprise.

### SUMMARY

Objectives of the present invention are to provide a method, an apparatus, and a system for generating a business model, and a computer readable storage medium.

A method for generating a business model is disclosed, where the method includes the following steps:

obtaining stakeholder information, activity information, and resource information in a symbiosis scope;

slicing stakeholders, activities, and resources to obtain fine-granularity stakeholders, activities, and resources; and

regrouping the fine-granularity stakeholders, activities, and resources, and generating a series of new business models.

An apparatus for generating a business model is disclosed, where the apparatus includes:

an information obtaining unit, configured to obtain stakeholder information, activity information, and resource information in a symbiosis scope;

a slicing unit, configured to slice stakeholders, activities, and resources to obtain fine-granularity stakeholders, activities, and resources; and

a regrouping unit, configured to regroup the fine-granularity stakeholders, activities, and resources, and generate a series of new business models.

A system for generating a business model is disclosed, where the system includes:

a bus, configured to transmit signaling and data;

a user interface adapter, configured to connect an input device to the bus, and receive stakeholder information, activity information, and resource information in a symbiosis scope that are input by a user;

a display adapter, configured to connect a display device to the bus, display an interface for inputting the stakeholder information, activity information, and resource information, and display a series of generated new business models; and

a business model generation apparatus, configured to receive the stakeholder information, activity information, and resource information in the symbiosis scope that are transmitted by the user interface adapter through the bus, slice stakeholders, activities, and resources to obtain fine-granularity stakeholders, activities, and resources, regroup the fine-granularity stakeholders, activities, and resources, generate a series of new business models, and transmit the business models to the display adapter through the bus.

A computer readable storage medium is disclosed, where the computer readable storage medium stores a computer program instruction executable by a computer, and when the computer executes the computer program instruction, the computer executes a method for generating a business model, where the method for generating a business model includes:

obtaining stakeholder information, activity information, and resource information in a symbiosis scope;

slicing stakeholders, activities, and resources to obtain fine-granularity stakeholders, activities, and resources; and

regrouping the fine-granularity stakeholders, activities, and resources, and generating a series of new business models.

In specific implementation manners of a method and an apparatus for generating a business model according to the present invention, stakeholder information, activity information, and resource information in a symbiosis scope are obtained; stakeholders, activities, and resources are sliced, so that fine-granularity stakeholders, activities, and resources are obtained; the fine-granularity stakeholders, activities, and resources are further regrouped, and a series of new business models is generated. Therefore, innovations of business models are implemented, and the generated series of business models may be provided for an enterprise to make a selection according to conditions of the enterprise.

### BRIEF DESCRIPTION OF THE DRAWINGS

FIG 1 is a flowchart of a specific implementation manner of a method for generating a business model according to the present invention;

FIG. 2 is a flowchart of a specific implementation manner of slicing stakeholders, activities, and resources according to the present invention;

FIG. 3 is a flowchart of a specific implementation manner of regrouping fine-granularity stakeholders, activities, and resources according to the present invention;

FIG. 4 is a table of association relationships between stakeholders and resources according to the present invention;

FIG. 5 is a table of association relationships between activities and resources according to the present invention;

FIG. 6 is a table of association relationships between stakeholders and activities according to the present invention;

FIG. 7 is a table of transaction relationships between stakeholders according to the present invention;

FIG. 8 is a schematic block diagram of a specific implementation manner of an apparatus for generating a business model according to the present invention; and

FIG. 9 is a schematic block diagram of a specific implementation manner of a system for generating a business model according to the present invention.

### DESCRIPTION OF THE EMBODIMENTS

In the present invention, stakeholder information, activity information, and resource information are input, and after stakeholders, activities, and resources are sliced and regrouped, a series of new business models is generated for an enterprise to make a selection, so that the enterprise obtains a business model suitable for the enterprise.

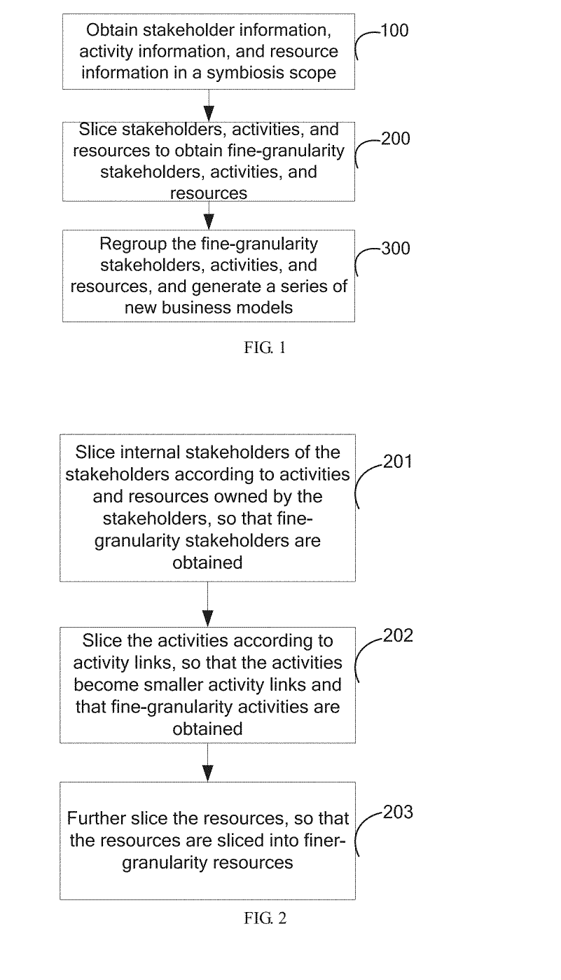

FIG. 1 shows a specific implementation manner of a method for generating a business model according to the present invention. The method includes:

Step 100: Obtain stakeholder information, activity information, and resource information in a symbiosis scope.

In the present invention, a symbiosis is a sum of business models of an enterprise under analysis and business models of stakeholders thereof. Horizontally in an entire activity value chain and vertically in an entire industry value chain, the symbiosis scope refers to (internal and external) stakeholders and activities of the stakeholders that have mutual transactions.

In the present invention, stakeholders are any stakeholders that are affected by a decision or an action of an enterprise under analysis, in internal and external environments of the enterprise under analysis. The stakeholders may be external stakeholders, for example, creditors, suppliers, retailers, and governments, and may be internal stakeholders, for example, employees and shareholders. To define a stakeholder of an enterprise under analysis, it is necessary to determine whether a decision or an action of the stakeholder is affected by the enterprise under analysis. For example, a supplier of an enterprise is apparently a stakeholder of the enterprise, because a decision of the supplier is apparently affected by the enterprise.

In the present invention, the stakeholders in the symbiosis scope may include only the internal and external stakeholders in the existing business models, or may include the internal and external stakeholders in the existing business models and newly introduced stakeholders.

Resources refer to features that are controlled by an enterprise under analysis to implement a strategy of the enterprise under analysis and used to improve operational performance and efficiency of the enterprise under analysis, including all properties, capacities, competitiveness, processes of the enterprise under analysis, features of the enterprise under analysis, data, information, knowledge, and the like.

In the present invention, activities refer to specific actions of various stakeholders of an enterprise under analysis. For example, characteristics of production, research and development, sale, logistics, after-sales service, and activities may be specifically described by using attributes of activities.

The attributes of activities are used to specifically describe characteristics of a type of activity. For example, attributes of production refer to activities and processes of creating corporeal properties; attributes of research and development refer to systematic activities with clear goals, which are continuously carried out by various research institutes and enterprises in order to acquire new knowledge of science and technology (not including humanities and social science), creatively apply new knowledge of science and technology, or substantially improve technologies, products, and services.

In the present invention, the stakeholder information, activity information, and resource information may be entered directly by a user, or may be obtained by analyzing a business model of an existing enterprise under analysis and business models of stakeholders of the enterprise under analysis in the symbiosis scope.

Step 200: Slice stakeholders, activities, and resources to obtain fine-granularity stakeholders, activities, and resources.

Referring to FIG. 2, in the present invention, the step of slicing stakeholders, activities, and resources to obtain fine-granularity stakeholders, activities, and resources is specifically as follows:

Step 201: Slice internal stakeholders of the stakeholders according to activities and resources owned by the stakeholders, so that fine-granularity stakeholders are obtained.

Step 202: Slice the activities according to activity links, so that the activities become smaller activity links and that fine-granularity activities are obtained; where, granularities of slicing may vary according to different purposes of slicing.

Step 203: Further slice the resources, so that the resources are sliced into finer-granularity resources; where, for example, original resources of stakeholders are a combination of various resources such as capital and human resources, which are sliced into capital resources and human resources, and granularities of slicing may vary according to different purposes of slicing.

In the present invention, the stakeholders, activities, and resources need to be reconfigured after they are sliced, so that transaction value of a business model is increased. Therefore, during slicing of the stakeholders, activities, and resources, if it is determined that the transaction value of the business model cannot be increased by slicing, slicing is inappropriate, and vice versa.

It may be understood that in an actual application, the foregoing steps 201, 202, and 203 may be interchanged, and that the sequence thereof is not limited.

Step 300: Regroup the fine-granularity stakeholders, activities, and resources, and generate a series of new business models.

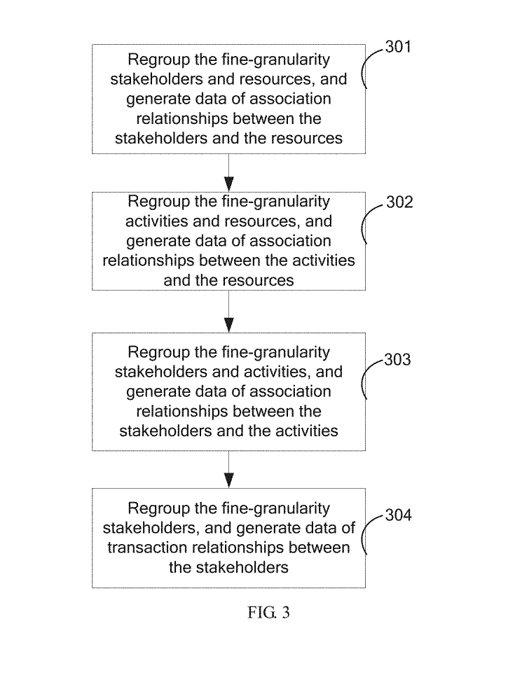

Referring to FIG. 3, in the present invention, the step of regrouping the fine-granularity stakeholders, activities, and resources is specifically:

Step 301: Regroup the fine-granularity stakeholders and resources, and generate data of association relationships between the stakeholders and the resources.

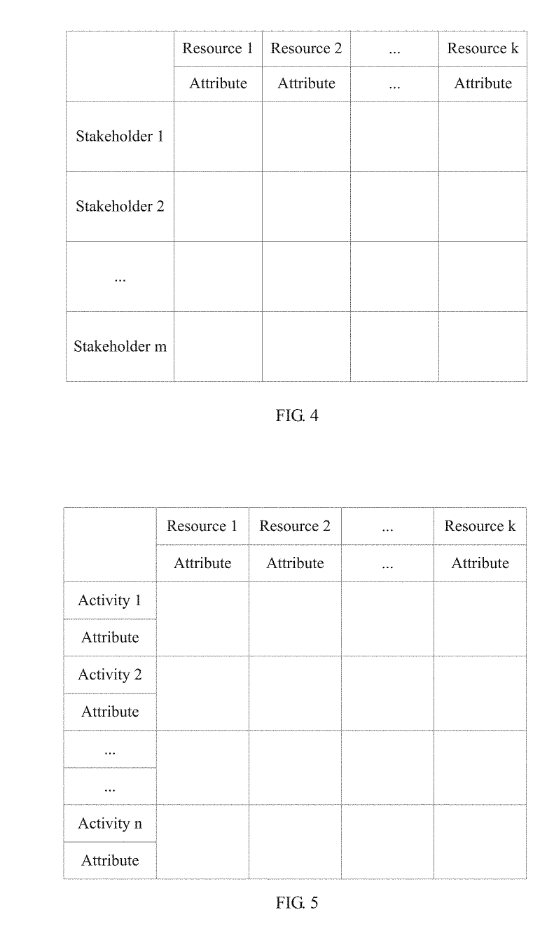

In an embodiment of the present invention, the data of association relationships between the stakeholders and the resources may be presented by a table of relationships between the stakeholders and the resources shown in FIG. 4.

Step 302: Regroup the fine-granularity activities and resources, and generate data of association relationships between the activities and the resources.

In an embodiment of the present invention, the data of association relationships between the activities and the resources may be presented by a table of relationships between the activities and the resources shown in FIG. 5.

Step 303: Regroup the fine-granularity stakeholders and activities, and generate data of association relationships between the stakeholders and the activities.

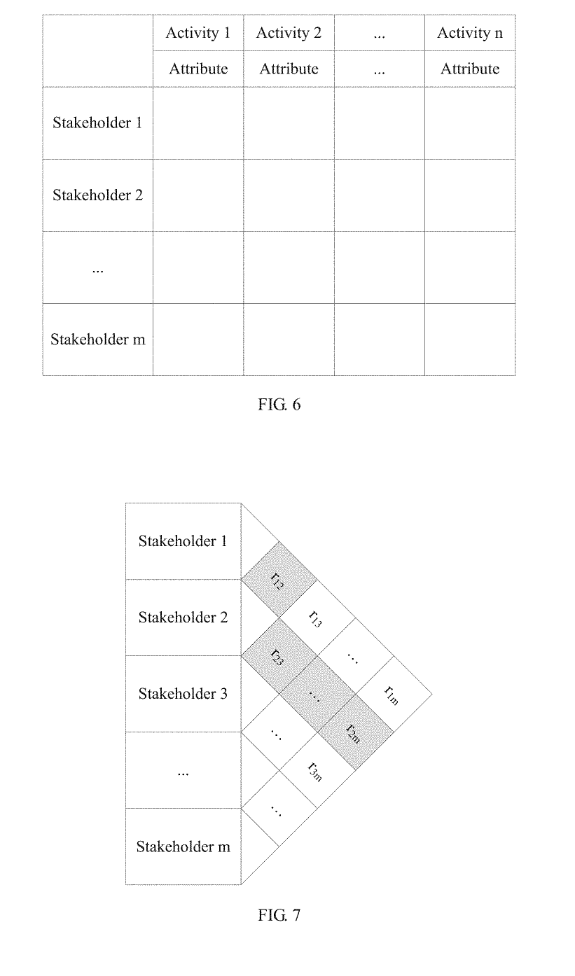

In an embodiment of the present invention, the data of association relationships between the stakeholders and the activities may be presented by a table of relationships between the stakeholders and the activities shown in FIG. 6.

Step 304: Regroup the fine-granularity stakeholders, and generate data of transaction relationships between the stakeholders.

In an embodiment of the present invention, the data of transaction relationships between the stakeholders may be presented by a table of transaction relationships between the stakeholders shown in FIG. 7.

It may be understood that in an actual application, the foregoing steps 301, 302, 303, and 304 may be interchanged, and that the sequence thereof is not limited.

A set including the foregoing data of association relationships between the activities and the resources, the data of association relationships between the activities and the resources, the data of association relationships between the stakeholders and the activities, and the data of transaction relationships between the stakeholders is a new business model.

In a specific implementation manner of a method for generating a business model according to the present invention, stakeholder information, activity information, and resource information in a symbiosis scope are determined and input; stakeholders, activities, and resources are sliced, so that fine-granularity stakeholders, activities, and resources are obtained; the fine-granularity stakeholders, activities, and resources are further regrouped, and a series of new business models is generated. Because the fine-granularity stakeholders, activities, and resources obtained by slicing are completely new in contrast to the original stakeholders, activities, and resources, and there are multiple possibilities of regrouping of the fine-granularity stakeholders, activities, and resources, the generated series of business models is completely new in contrast to original business models. Therefore, innovations of business models are implemented, and the generated series of business models may be provided for an enterprise to make a selection according to conditions of the enterprise.

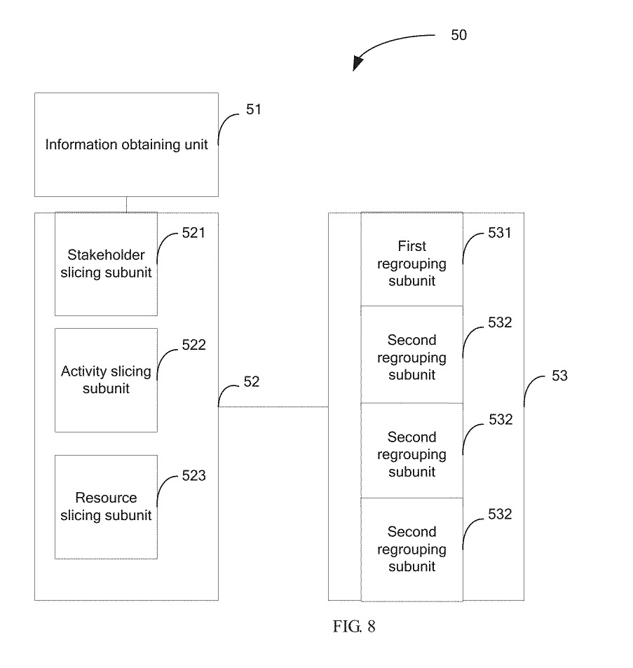

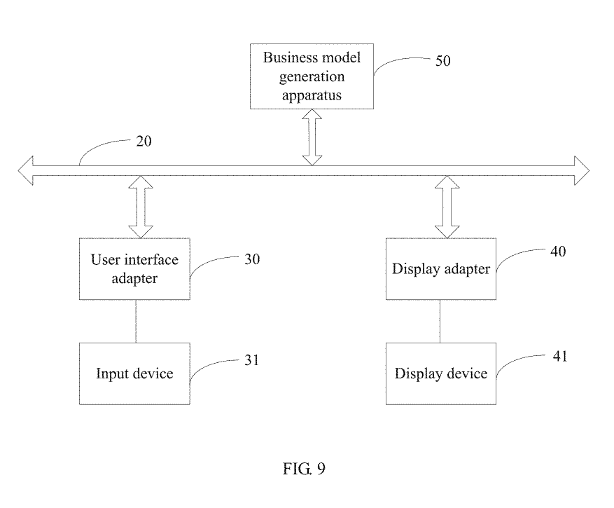

FIG. 8 shows a specific implementation manner of an apparatus for generating a business model according to the present invention. The apparatus 50 includes an information obtaining unit 51, a slicing unit 52, and a regrouping unit 53.

The information obtaining unit 51 is configured to obtain stakeholder information, activity information, and resource information in a symbiosis scope.

In the present invention, a symbiosis is a sum of business models of an enterprise under analysis and business models of stakeholders thereof. Horizontally in an entire activity value chain and vertically in an entire industry value chain, the symbiosis scope refers to (internal and external) stakeholders and activities of the stakeholders that have mutual transactions.

In the present invention, stakeholders are any stakeholders that are affected by a decision or an action of an enterprise under analysis, in internal and external environments of the enterprise under analysis. The stakeholders may be external stakeholders, for example, creditors, suppliers, retailers, and governments, and may be internal stakeholders, for example, employees and shareholders. To define a stakeholder of an enterprise under analysis, it is necessary to determine whether a decision or an action of the stakeholder is affected by the enterprise under analysis. For example, a supplier of an enterprise is apparently a stakeholder of the enterprise, because a decision of the supplier is apparently affected by the enterprise.

Resources refer to features that are controlled by an enterprise under analysis to implement a strategy of the enterprise under analysis and used to improve operational performance and efficiency of the enterprise under analysis, including all properties, capacities, competitiveness, processes of the enterprise under analysis, features of the enterprise under analysis, data, information, knowledge, and the like.

In the present invention, activities refer to specific actions of various stakeholders of an enterprise under analysis. For example, characteristics of production, research and development, sale, logistics, after-sales service, and activities may be specifically described by using attributes of activities.

The attributes of activities are used to specifically describe characteristics of a type of activity. For example, attributes of production refer to activities and processes of creating corporeal properties; attributes of research and development refer to systematic activities with clear goals, which are continuously carried out by various research institutes and enterprises in order to acquire new knowledge of science and technology (not including humanities and social science), creatively apply new knowledge of science and technology, or substantially improve technologies, products, and services.

In the present invention, the stakeholder information, activity information, and resource information may be entered directly by a user, or may be obtained by analyzing a business model of an existing enterprise under analysis and business models of stakeholders of the enterprise under analysis in the symbiosis scope.

The slicing unit 52 is configured to slice stakeholders, activities, and resources to obtain fine-granularity stakeholders, activities, and resources.

In the present invention, the slicing unit 52 includes:

a stakeholder slicing subunit 521, configured to slice internal stakeholders of the stakeholders according to activities and resources owned by the stakeholders, so that fine-granularity stakeholders are obtained;

an activity slicing subunit 522, configured to slice the activities according to activity links, so that the activities become smaller activity links and that fine-granularity activities are obtained; and

a resource slicing subunit 523, configured to further slice the resources, so that the resources are sliced into finer-granularity resources.

In the present invention, the stakeholders, activities, and resources need to be reconfigured after they are sliced, so that transaction value of a business model is increased. Therefore, during slicing of the stakeholders, activities, and resources, if it is determined that the transaction value of the business model cannot be increased by slicing, slicing is inappropriate, and vice versa.

The regrouping unit 53 is configured to regroup the fine-granularity stakeholders, activities, and resources, and generate a series of new business models.

In the present invention, the regrouping unit 53 includes a first regrouping subunit 531, a second regrouping subunit 532, a third regrouping subunit 533, and a fourth regrouping subunit 534.

The first regrouping subunit 531 is configured to regroup the fine-granularity stakeholders and resources, and generate data of association relationships between the stakeholders and the resources.

In an embodiment of the present invention, the data of association relationships between the stakeholders and the resources may be presented by a table of relationships between the stakeholders and the resources shown in FIG. 4.

The second regrouping subunit 532 is configured to regroup the fine-granularity activities and resources, and generate data of association relationships between the activities and the resources.

In an embodiment of the present invention, the data of association relationships between the activities and the resources may be presented by a table of relationships between the activities and the resources shown in FIG. 5.

The third regrouping subunit 533 is configured to regroup the fine-granularity stakeholders and activities, and generate data of association relationships between the stakeholders and the activities.

In an embodiment of the present invention, the data of association relationships between the stakeholders and the activities may be presented by a table of relationships between the stakeholders and the activities shown in FIG. 6.

The fourth regrouping subunit 534 is configured to regroup the fine-granularity stakeholders, and generate data of transaction relationships between the stakeholders.

In an embodiment of the present invention, the data of transaction relationships between the stakeholders may be presented by a table of transaction relationships between the stakeholders shown in FIG. 7.

In the present invention, a set including the data of association relationships between the activities and the resources, the data of association relationships between the activities and the resources, the data of association relationships between the stakeholders and the activities, and the data of transaction relationships between the stakeholders is a new business model.

In a specific implementation manner of an apparatus for generating a business model according to the present invention, stakeholder information, activity information, and resource information in a symbiosis scope are determined and input; stakeholders, activities, and resources are sliced, so that fine-granularity stakeholders, activities, and resources are obtained; the tine-granularity stakeholders, activities, and resources are further regrouped, and a series of new business models is generated. Because the fine-granularity stakeholders, activities, and resources obtained by slicing are completely new in contrast to the original stakeholders, activities, and resources, and there are multiple possibilities of regrouping of the fine-granularity stakeholders, activities, and resources, the generated series of business models is completely new in contrast to original business models. Therefore, innovations of business models are implemented, and the generated series of business models may be provided for an enterprise to make a selection according to conditions of the enterprise.

FIG. 9 shows a specific implementation manner of a system for generating a business model. The system includes:

a bus 20, configured to transmit signaling and data;

a user interface adapter 30, configured to connect an input device 31 to the bus 20, and receive stakeholder information, activity information, and resource information in a symbiosis scope that are input by a user, where the input device includes but is not limited to a keyboard, a mouse, a speaker, a microphone, or the like;

a display adapter 40, configured to connect a display device 41 to the bus 20, display an interface for inputting the stakeholder information, activity information, and resource information, and display a series of generated new business models, where the display device may be a display, a printer, or an information generation apparatus; and

a business model generation apparatus 50, as described in the specific implementation manner corresponding to FIG. 4, configured to receive the stakeholder information, activity information, and resource information in the symbiosis scope that are transmitted by the user interface adapter 30 through the bus 20, slice stakeholders, activities, and resources to obtain fine-granularity stakeholders, activities, and resources, regroup the fine-granularity stakeholders, activities, and resources, generate a series of new business models, and transmit the business models to the display adapter 40 through the bus 20.

The business model generation apparatus 50 may be implemented by hardware, or implemented by software, or implemented by a combination of software and hardware.

The apparatus is not described exhaustively herein. For detailed information, reference may be made to the detailed description in the specific implementation manner of the apparatus for generating a business model.

In a specific implementation manner of a system for generating a business model according to the present invention, stakeholder information, activity information, and resource information in a symbiosis scope are determined and input; stakeholders, activities, and resources are sliced, so that fine-granularity stakeholders, activities, and resources are obtained; the fine-granularity stakeholders, activities, and resources are further regrouped, and a series of new business models is generated. Therefore, innovations of business models are implemented, and the generated series of business models may be provided for an enterprise to make a selection according to conditions of the enterprise.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

1. A method for generating a business model, wherein the method comprises the following steps:
obtaining stakeholder information, activity information, and resource information in a symbiosis scope;
slicing stakeholders, activities, and resources to obtain fine-granularity stakeholders, activities, and resources; and
regrouping the fine-granularity stakeholders, activities, and resources, and generating a series of new business models.

2. The method for generating a business model according to claim 1, wherein the step of slicing stakeholders, activities, and resources to obtain fine-granularity stakeholders, activities, and resources is specifically:
slicing internal stakeholders of the stakeholders according to activities and resources owned by the stakeholders, so that fine-granularity stakeholders are obtained;
slicing the activities according to activity links, so that the activities become smaller activity links and that fine-granularity activities are obtained; and
further slicing the resources, so that the resources are sliced into finer-granularity resources.

3. The method for generating a business model according to claim 1, wherein the step of regrouping the fine-granularity stakeholders, activities, and resources comprises the following steps:
regrouping the fine-granularity stakeholders and resources, and generating data of association relationships between the stakeholders and the resources;
regrouping the fine-granularity activities and resources, and generating data of association relationships between the activities and the resources;
regrouping the fine-granularity stakeholders and activities, and generating data of association relationships between the stakeholders and the activities; and
regrouping the fine-granularity stakeholders, and generating data of transaction relationships between the stakeholders.

4. An apparatus for generating a business model, wherein the apparatus comprises:
an information obtaining unit, configured to obtain stakeholder information, activity information, and resource information in a symbiosis scope;
a slicing unit, configured to slice stakeholders, activities, and resources to obtain fine-granularity stakeholders, activities, and resources; and
a regrouping unit, configured to regroup the fine-granularity stakeholders, activities, and resources, and generate a series of new business models.

5. The apparatus for generating a business model according to claim 4, wherein the slicing unit comprises:
a stakeholder slicing subunit, configured to slice internal stakeholders of the stakeholders according to activities and resources owned by the stakeholders, so that fine-granularity stakeholders are obtained;
an activity slicing subunit, configured to slice the activities according to activity links, so that the activities become smaller activity links and that fine-granularity activities are obtained;
a resource slicing subunit, configured to further slice the resources, so that the resources are sliced into finer-granularity resources.

6. The apparatus for generating a business model according to claim 4, wherein the regrouping unit comprises:
a first regrouping subunit, configured to regroup the fine-granularity stakeholders and resources, and generate data of association relationships between the stakeholders and the resources;
a second regrouping subunit, configured to regroup the fine-granularity activities and resources, and generate data of association relationships between the activities and the resources:
a third regrouping subunit, configured to regroup the fine-granularity stakeholders and activities, and generate data of association relationships between the stakeholders and the activities; and
a fourth regrouping subunit, configured to regroup the fine-granularity stakeholders, and generate data of transaction relationships between the stakeholders.

7. A system for generating a business model, wherein the system comprises:
a bus, configured to transmit signaling and data;
a user interface adapter, configured to connect an input device to the bus, and receive stakeholder information, activity information, and resource information in a symbiosis scope that are input by a user;
a display adapter, configured to connect a display device to the bus, display an interface for inputting the stakeholder information, activity information, and resource information, and display a series of generated new business models; and
a business model generation apparatus, configured to receive the stakeholder information, activity information, and resource information in the symbiosis scope that are transmitted by the user interface adapter through the bus, slice stakeholders, activities, and resources to obtain fine-granularity stakeholders, activities, and resources, regroup the fine-granularity stakeholders, activities, and resources, generate a series of new business models, and transmit the business models to the display adapter through the bus.

8. The system for generating a business model according to claim 7, wherein the business model generation apparatus comprises:
an information obtaining unit, configured to obtain stakeholder information, activity information, and resource information in a symbiosis scope;
a slicing unit, configured to slice stakeholders, activities, and resources to obtain fine-granularity stakeholders, activities, and resources; and
a regrouping unit, configured to regroup the fine-granularity stakeholders, activities, and resources, and generate a series of new business models.

9. The system for generating a business model according to claim 8, wherein the slicing unit comprises:
a stakeholder slicing subunit, configured to slice internal stakeholders of the stakeholders according to activities and resources owned by the stakeholders, so that fine-granularity stakeholders are obtained;
an activity slicing subunit, configured to slice the activities according to activity links, so that the activities become smaller activity links and that fine-granularity activities are obtained;
a resource slicing subunit, configured to further slice the resources, so that the resources are sliced into finer-granularity resources.

10. The system for generating a business model according to claim 8, wherein the regrouping unit comprises:
a first regrouping subunit, configured to regroup the fine-granularity stakeholders and resources, and generate data of association relationships between the stakeholders and the resources;
a second regrouping subunit, configured to regroup the fine-granularity activities and resources, and generate data of association relationships between the activities and the resources:
a third regrouping subunit, configured to regroup the fine-granularity stakeholders and activities, and generate data of association relationships between the stakeholders and the activities: and
a fourth regrouping subunit, configured to regroup the fine-granularity stakeholders, and generate data of transaction relationships between the stakeholders.

11. A computer readable storage medium, wherein the computer readable storage medium stores a computer program instruction executable by a computer, and when the computer executes the computer program instruction, the computer executes a method for generating a business model, wherein the method for generating a business model comprises:
obtaining stakeholder information, activity information, and resource information in a symbiosis scope;
slicing stakeholders, activities, and resources to obtain fine-granularity stakeholders, activities, and resources; and
regrouping the fine-granularity stakeholders, activities, and resources, and generating a series of new business models.

12. The computer readable storage medium according to claim 11, wherein the step of slicing stakeholders, activities, and resources to obtain fine-granularity stakeholders, activities, and resources is specifically:
slicing internal stakeholders of the stakeholders according to activities and resources owned by the stakeholders, so that fine-granularity stakeholders are obtained;
slicing the activities according to activity links, so that the activities become smaller activity links and that fine-granularity activities are obtained; and
further slicing the resources, so that the resources are sliced into finer-granularity resources.

13. The computer readable storage medium according to claim 11, wherein the step of regrouping the fine-granularity stakeholders, activities, and resources comprises the following steps:
regrouping the sliced fine-granularity stakeholders with stakeholders, regrouping the sliced fine-granularity activities with activities, regrouping the sliced fine-granularity resources with resources, and generating a series of combinations of stakeholders, combinations of activities, and combinations of resources;
regrouping the sliced fine-granularity stakeholders, activities, and resources, and generating a combination of stakeholders, activities, and resources; and
regrouping the combinations of stakeholders, the combinations of activities, and the combinations of resources with the sliced fine-granularity stakeholders, activities, and resources, and generating a combination of stakeholders, activities, and resources.
